(19) United States
(12) Patent Application Publication
(10) Pub. No.: US 2021/0045499 A1
(43) Pub. Date: Feb. 18, 2021

(54) Compact Ratcheting Buckle Mechanism

(71) Applicant: Swift-Strap LLC, Watertown, MA (US)

(72) Inventors: Nickolas Peter Demas, Watertown, MA (US); Anton Stuart Hunt, Belmont, MA (US)

(21) Appl. No.: 16/963,501

(22) PCT Filed: Jan. 21, 2019
(86) PCT No.: PCT/IB19/50471

§ 371 Date: Jul. 20, 2020

Related U.S. Application Data
(60) Provisional application No. 62/619,903, filed on Jan. 21, 2018.

(51) Int. Cl. A44B 11/06; A43C 11/14; A44B 11/10

(52) U.S. Cl. CPC A44B 11/065; B60P 7/083; A44B 11/10; A43C 11/14

(57) ABSTRACT

A compact ratcheting buckle mechanism which enables significant mechanical advantage can be used in a multitude of devices. The compact ratcheting buckle mechanism comprises a base plate which holds a ratchet tab and release tab, which are spring-loaded and held in place by pivot pins which pass through slots in the base plate. The ratchet and release tabs are then able to articulate. The ratchet tab teeth engage with a compatible ratchet ladder strap, which passes through the compact ratcheting buckle mechanism linearly when the ratchet tab is articulated. The release tab holds applied tension in the compact ratcheting buckle mechanism, and is substantially covered by the ratchet tab to ensure for a compact design and low chance of accidental release. The compact ratcheting buckle mechanism can be released through a defined pincer motion, disengaging both the ratchet tab and release tab teeth from the compatible ratchet ladder strap.

### RELATED APPLICATIONS

This application claims the benefit of U.S. Provisional Application No. 62/619,903, filed on Jan. 21, 2018. The entire teachings of the above application are incorporated herein by reference.

### BACKGROUND

The field of the invention disclosed in this PCT application relates to a compact ratcheting buckle mechanism. The ratchet buckle is a well-known concept, but methods/procedures/geometries to ratchet and release the mechanism (when under tension) may be flimsy, complicated, and/or physically difficult to actuate. Some examples of compact ratcheting buckle mechanisms can be found in U.S. Pat. Nos. 8,763,209 and 6,748,630, and PCT/US2012/038475. The ratchet buckle mechanism disclosed in this PCT application is intended for use with a multitude of situations where adjustable tension is desired between two structures.

The compact ratcheting buckle mechanism is intended for (but not restricted to) use in applications where webbing loop compression devices (for example a medical tourniquet compression device, a ski binding, or a tie down) require additional mechanical advantage to apply elevated tension forces in the webbing. One application of this compact ratcheting buckle mechanism is for use in the compression device described by PCT/US2016/022882. The mechanical advantage produced by the device disclosed in this invention allows for a user to greatly increase the compression force when the compression device is applied around an object by hand.

### SUMMARY OF THE INVENTION

Described is a novel compact ratcheting buckle mechanism, which can be used to generate significant mechanical advantage by means of affecting a ratchet tab (lever) with a large moment arm. This ratchet tab acts upon a linearly movable ratchet ladder strap, which when anchored to other components can be used for tightening in a multitude of devices. One particular application is for use in a compression device, or more specifically, on a compression medical device, such as a tourniquet.

For compression medical devices used in the field, size and weight are important to ensure the device is portable. For use in the field under a wide range of operating conditions, the ratcheting buckle must be easy to operate with gross motor skills. For critical life-saving compression medical devices relying on the mechanical advantage afforded by a ratcheting buckle, it is also important that the ratcheting buckle cannot be released easily or on accident—the release function needs to be only possible through a very deliberate user manipulation.

The concept of a ratcheting buckle mechanism is certainly well-known, with many disclosed designs. However, none of them completely meet the design requirements listed here. Some ratcheting buckles, such as that disclosed in US2014/0157626, have a ratchet and pawl assembled side-by-side rather than nested or integrated together, resulting in a larger ratcheting buckle mechanism footprint. Other designs from the prior art, such as those disclosed by U.S. Pat. Nos. 5,606,779 and 6,729,047, feature narrowing ratchet tab (lever) handles, resulting in harder to operate ratchet tabs with gross motor skills than if the handle were to be designed with a wider footprint. Compact ratcheting buckles, often used in the sports equipment industry (for example for use in cycling shoes, ski and snowboard bindings) are frequently designed to be easy to release—designs in the prior art disclosed by U.S. Pat. No. 6,729,047 and 2012/0297591 showcasing quick release tabs which can be activated through holes/openings in the ratchet tab (lever)—these release mechanisms could be affected on accident which would be catastrophic if used on a critical medical compression device, such as a tourniquet.

These requirements and the lack of a single solution to address each of these in the prior art have led to the development of the disclosed invention. A compact ratcheting buckle mechanism, whereby both the ratchet tab and release tab are assembled to nest together, is thus described in this application. The ratchet lever is designed with a wider ratchet tab handle (wider than the rest of the ratchet tab) to maximize ease of ratcheting operation with gross motor skills. The ratchet tab also substantially covers the release tab, thereby requiring a very defined pincer (squeeze release) motion to release the mechanism—this severely reduces the chance of accidental release for example once the compression device has been applied to a subject, ratchet set and the subject is dragged along the ground/a rough surface.

At especially high ratcheting loads, there is also a concern that the thinner/more delicate ratchet tab teeth features will fail at relatively low load cases. The invention disclosed in this application thus shows a novel design using reinforcing ribs that run orthogonal to the teeth direction, to greatly increase the strength of teeth of a given geometry and material. The ratchet ladder strap is adjusted accordingly to accept these additional rib features. This design feature is thus intended to greatly strengthen the ratchet tab and release tab teeth, which greatly improves the overall strength of the ratcheting buckle mechanism by increasing the failure loads of the weakest features.

### BRIEF DESCRIPTION OF THE DRAWINGS

The foregoing will be apparent from the following more particular description of components and features of the invention, as illustrated in the accompanying drawings in which like reference characters refer to the same parts throughout the different views. The drawings are not necessarily to scale, emphasis instead being placed upon illustrating components and features of the present invention.

FIG. 1 shows the isometric view of the compact ratcheting buckle mechanism and compatible ratchet ladder strap.

FIG. 2 shows the side view of the compact ratcheting buckle mechanism and compatible ratchet ladder strap.

FIG. 3 shows the top view of the compact ratcheting buckle mechanism and compatible ratchet ladder strap.

FIG. 4 shows the compact ratcheting buckle mechanism in position ¼.

FIG. 5 shows the compact ratcheting buckle mechanism in position ½.

FIG. 6 shows the compact ratcheting buckle mechanism in position ¾.

FIG. 7 shows the compact ratcheting buckle mechanism in position full.

FIG. 8 shows the squeeze-released state on the compact ratcheting buckle mechanism.

FIG. 9 shows the squeeze-released state on the compact ratcheting buckle mechanism (base plate hidden).

FIG. 10 shows the continuous base plate side view.

FIG. 11 shows the continuous base plate isometric view.

FIG. 12 shows the ratchet tab top view.

FIG. 13 shows the ratchet tab rear view.

FIG. 14 shows the ratchet tab side view.

FIG. 15 shows the ratchet tab bottom view.

FIG. 16 shows the release tab top view.

FIG. 17 shows the release tab side view.

FIG. 18 shows the release tab front view.

FIG. 19 shows the release tab bottom view.

FIG. 20 shows the release tab isometric view.

FIG. 21 shows the compatible ratchet ladder strap isometric view.

### DETAILED DESCRIPTION OF THE INVENTION

The compact ratcheting buckle mechanism comprises of the three bespoke components: a ratchet tab, release tab and base plate. These components, when assembled, allow for a ratcheting action to occur on a fourth bespoke component: the compatible ratchet ladder strap. The compact ratcheting buckle mechanism and the compatible ratchet ladder strap together encompass the invention disclosed herein.

The ratchet tab, release tab and base plate are assembled together into the compact ratcheting buckle mechanism using non-bespoke assembly components; namely a first and second pivot pin and two double-torsion springs. This detailed description outlines the design, assembly and function of the ratchet tab, release tab and base plate which make up the compact ratcheting buckle mechanism, as well as the design, assembly and function of the compatible ratchet ladder strap with the compact ratcheting buckle mechanism. Note that the non-bespoke assembly hardware (first and second pivot pins and two double-torsion springs) are implied.

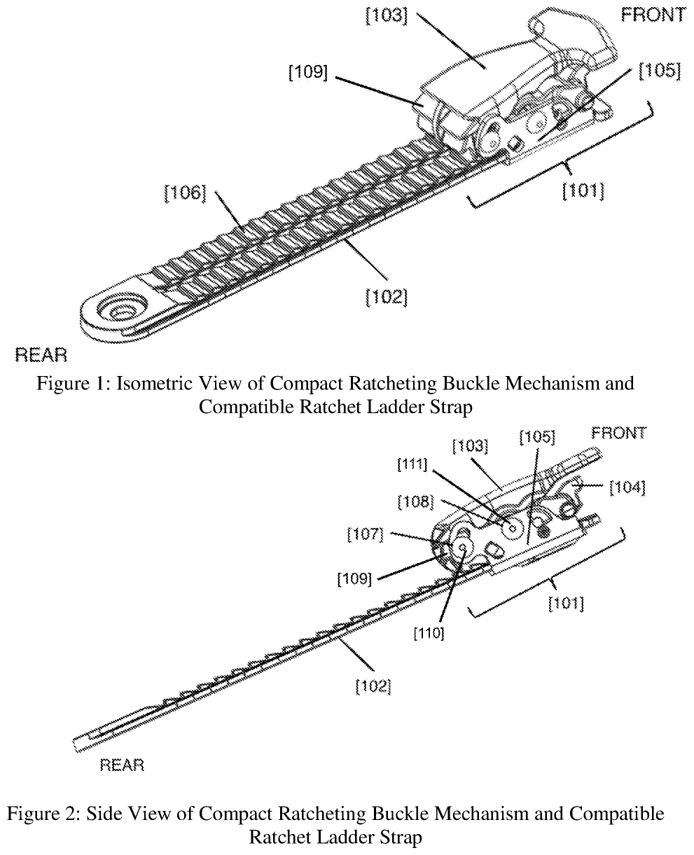

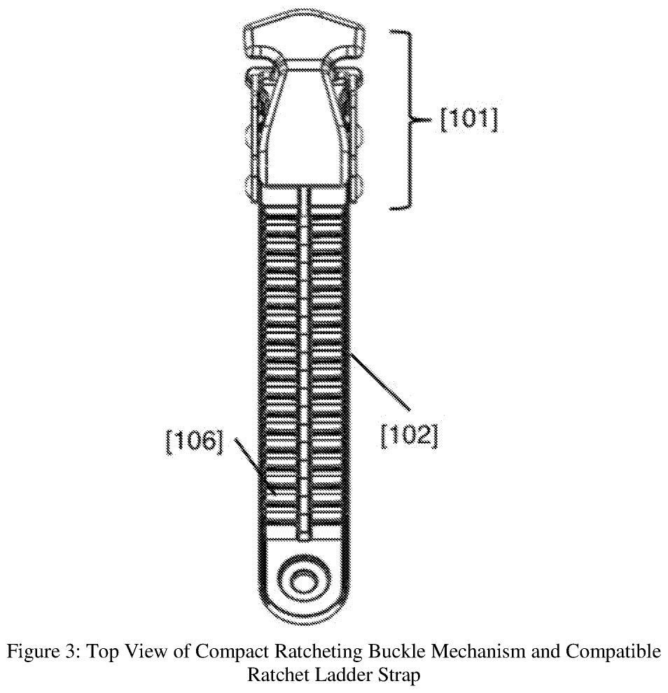

FIGS. 1 through 3 show the assembled compact ratcheting buckle mechanism [101] mated with the compatible ratchet ladder strap [102] from three separate viewpoints. The compatible ratchet ladder strap [102] is designed to slide through the compact ratcheting buckle mechanism [101], moving in the forward direction (towards the FRONT) as the compact ratcheting buckle mechanism [101] is positively engaged and in the reverse direction (towards the REAR) when the same mechanism [101] is squeeze-released in a pincer motion (disengaged).

The compact ratcheting buckle mechanism is comprised of three bespoke components: the ratchet tab [103], the release tab [104] and the base plate [105]. Broadly speaking, the ratchet tab [103] engages ratchet tab teeth [109] against the compatible ratchet ladder strap teeth [106] moving the compatible ratchet ladder strap [102] in the forward direction (towards the FRONT). The release tab [104] engages with the compatible ratchet ladder strap teeth [106] as they move through the compact ratcheting buckle mechanism [101], ensuring that the compatible ratchet ladder strap [102] cannot move in the reverse direction (towards the REAR) unless the release tab [104] is manipulated in the correct manner. The base plate [105] provides the structure to the compact ratcheting buckle mechanism [101].

The assembly of the compact ratcheting buckle mechanism [101] is completed through two sub-assemblies, using the first and second pivot pins [110]/[111], first and second slots [107]/[108] in the base plate [105], the two double-torsion springs, the ratchet tab [103] and release tab [104]. The ratchet tab [103] sub-assembly is completed through the first pivot pin [110] passing through the first slot [107], the ratchet tab [103] and one double-torsion spring (the first slot [107] positioned towards the REAR of the compact ratcheting buckle mechanism [101]), the double-torsion spring being concentrically anchored by the first pivot pin [110] so that a positive spring force has to be overcome to lift the ratchet tab [103]. The ratchet tab [103] is then free to articulate around the first slot [107], concentrically anchored by the first pivot pin [110]. The release tab [104] sub-assembly is completed through the second pivot pin [111] passing through the second slot [108], the release tab [104] and one double-torsion spring (the second slot [108] positioned towards the FRONT of the compact ratcheting buckle mechanism [101]), the double-torsion spring being concentrically anchored by the second pivot pin [111] so that a positive spring force has to be overcome to lift the release tab [104]. The release tab [104] is then free to articulate around the second slot [108], concentrically anchored by the second pivot pin [111]. The assembly of the compact ratcheting buckle mechanism [101] is thus completed by both the ratchet tab [103] sub-assembly and the release tab [104] sub-assembly combined.

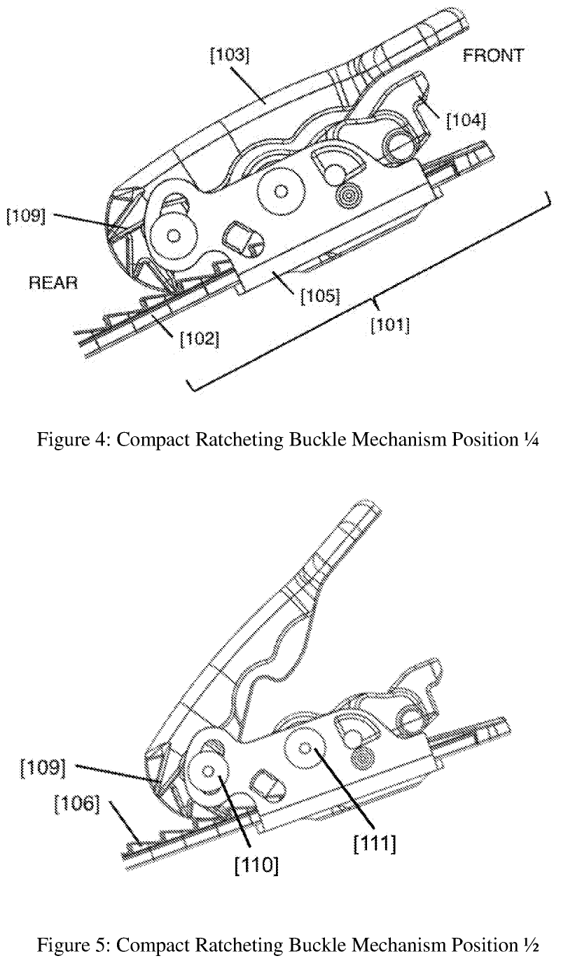

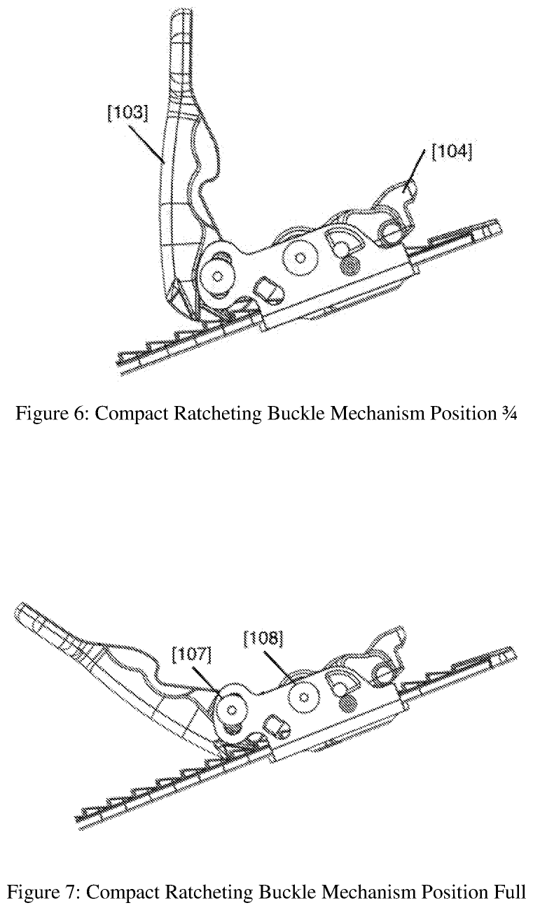

FIGS. 4 through 7 show a sequential four-step drawing of how the ratchet tab [103] levers through the compatible ratchet ladder strap [102]. Note how ratchet tab teeth [109] engage with the compatible ratchet ladder strap teeth [106], the moment arm between the front of the ratchet tab [103] and the ratchet tab teeth [109] (both relative to the first pivot pin [110] marking the center of rotation of ratchet tab [103]) is what results in the mechanical advantage the user experiences when using the compact ratcheting buckle mechanism [101]. As the teeth sequentially engage with the compatible ratchet ladder strap [102], the compatible ratchet ladder strap [102] is pushed in the forward direction (towards the FRONT). As the compatible ratchet ladder strap [102] moves forward, the release tab [104] rocks on the second pivot pin [111] between compatible ratchet ladder strap teeth [106], the release tab [104] possessing a ratchet lock-tooth which stops the compatible ratchet ladder strap [102] moving in the reverse direction (towards the REAR) unless the squeeze-release (using a pincer motion) technique is engaged on the compact ratcheting buckle mechanism [101]. The release tab [104] has a double-torsion spring (as described in the release tab [104] sub-assembly) which maintains a torsional force pressing the ratchet lock-tooth towards the compatible ratchet ladder strap [102]. This ensures for a positive engagement of the ratchet lock-tooth in any orientation so that the compact ratcheting buckle mechanism [101] does not rely on gravity to lock and hold any forward motion in the compatible ratchet ladder strap [102]. Note also that a second double-torsion spring (as described in the ratchet tab [103] sub-assembly) maintains a torsional force on ratchet tab [103] so that it is pressed down in the direction of the top of the release tab [104] (resting position as shown in FIG. 4). This torsional spring force ensures that the compact ratcheting buckle mechanism [101] is compact when held in any orientation but the torsional force is light enough that it can easily be overcome when a user lifts the ratchet tab [103]. During operation the base plate [105] serves the purpose of providing the housing and structure of the compact ratcheting buckle mechanism [101], providing the necessary centers of rotation when the first and second pivot pins [110]/[111] pass through and articulate within first and second slots [107]/[108] for both the ratchet tab [103] and the release tab [104].

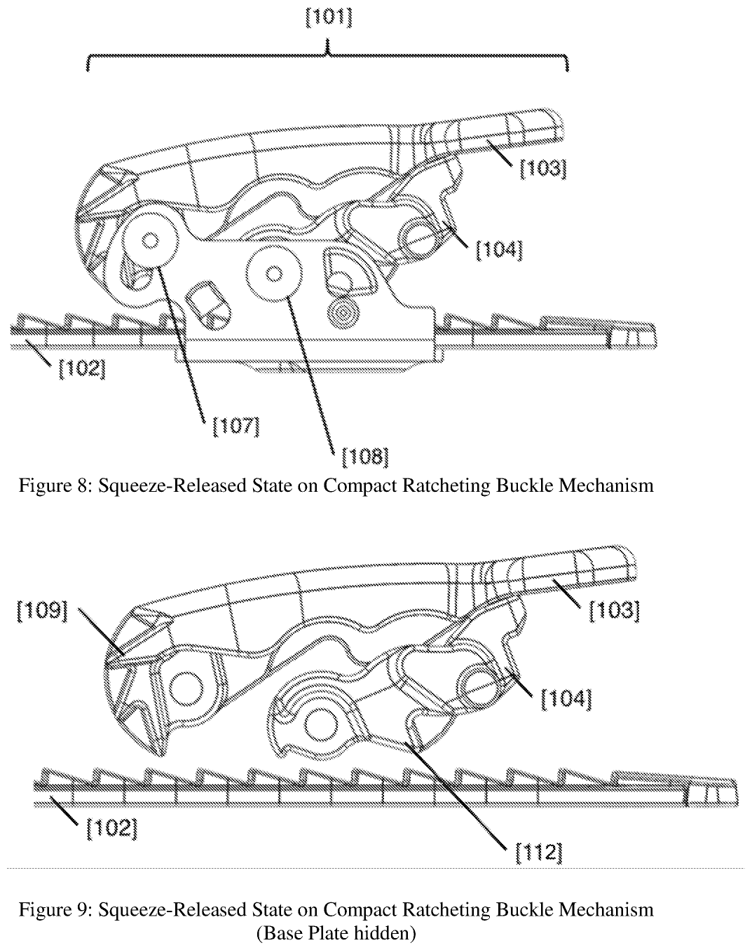

FIGS. 8 and 9 show the squeeze-release (pincer motion) effect which disengages both the ratchet tab [103] and the release tab [104] simultaneously from the compatible ratchet ladder strap [102] (FIG. 8 is with the base plate [105]; FIG. 9 is with the base plate [105] hidden): the effect of disengaging both of these parts means the compatible ratchet ladder strap [102] is now able to move in the reverse direction, undoing any ratcheting action. To achieve this release, the user has to overcome the restoring force of both double-torsion springs applied to the ratchet tab [103] and release tab [104] respectively (the torsional spring force pushing both of these parts towards the compatible ratchet ladder strap [102]). This is done via a squeezing or pincer motion (or similar) in which the release tab [104] articulates upwards in the second slot [108] from the front of the compact ratcheting buckle mechanism [101] whilst simultaneously squeezing against the rear of the ratchet tab [103] causing it to ride up in the first slot [107], disengaging the ratchet tab teeth [109] from the ratchet ladder strap [102]. The release tab [104] also thus disengages its ratchet lock-tooth [112], allowing movement of the ratchet ladder strap [102] in the reverse direction without impedance. It is intended for this squeeze-release pincer motion to require a specific maneuver for effective release, so that this cannot occur on accident.

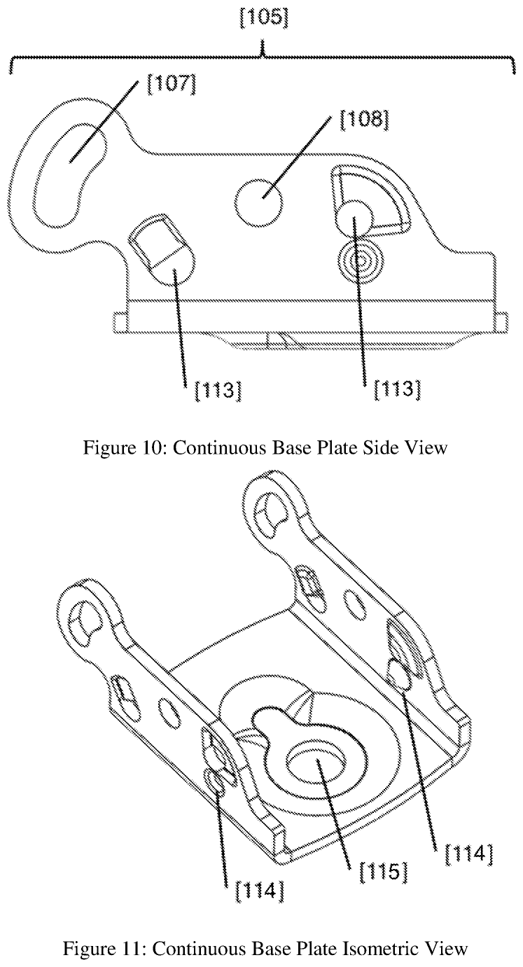

FIGS. 10 and 11 show a form of the base plate [105] in more detail. The base plate [105] must have the appropriate articulating slots (first slot [107] and second slot [108]) to allow for the motion of the ratchet tab [103] and release tab [104] (respectively) to move and function as described. The base plate [105] must also allow for the free linear motion (forward and reverse) of the compatible ratchet ladder strap [102] as described. Additionally, the base plate [105] can have further holes/features [113] which act as anchor points for the double-torsional springs described in the assembly. Furthermore, the base plate [105] also constrains the compatible ratchet ladder strap [102] in the vertical direction (away from the base plate [105]): constraining features [114] are shown in FIG. 11 prohibiting this motion orthogonal to the actuation direction of the compatible ratchet ladder strap [102]. Additionally, base plate [105] can have more hardware attachment holes [115] allowing for attachment of the whole compact ratcheting buckle mechanism [101] to a multitude of other components/fixings/hardware. Mounting features formed into the base plate [105] around the hardware attachment holes [115] like the one shown in FIG. 11 can dictate a mounting orientation to which a geometry on another component/fixings/hardware will nest.

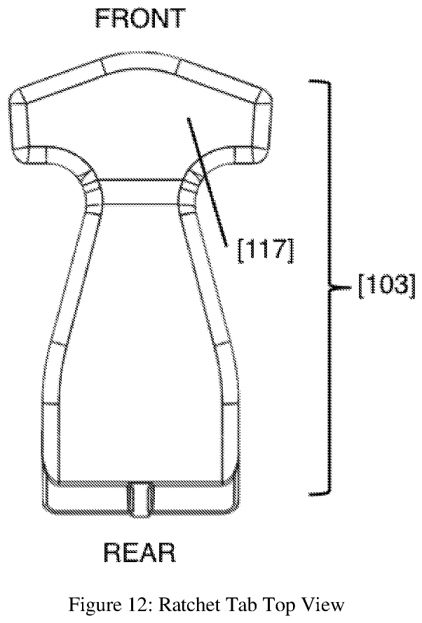

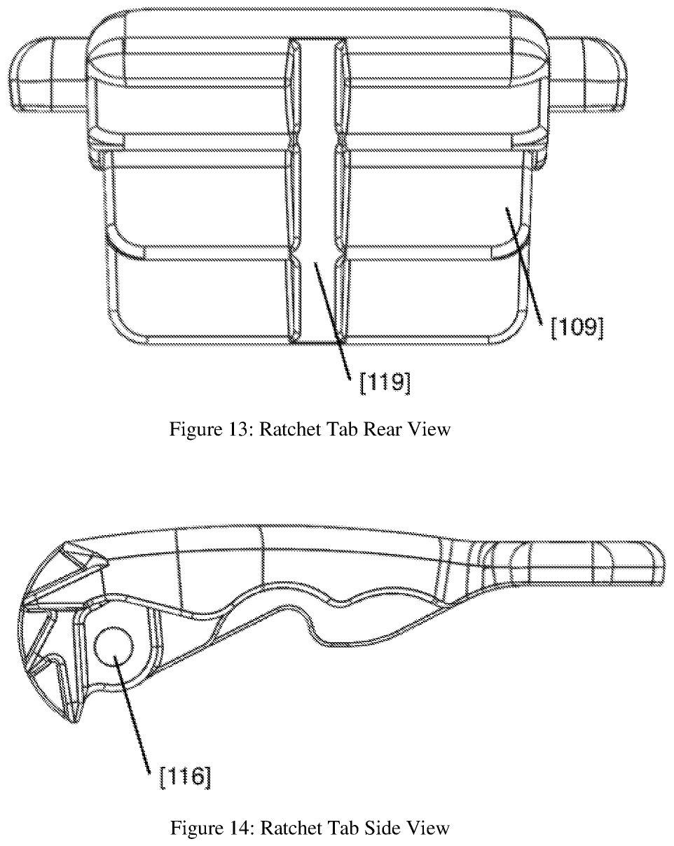

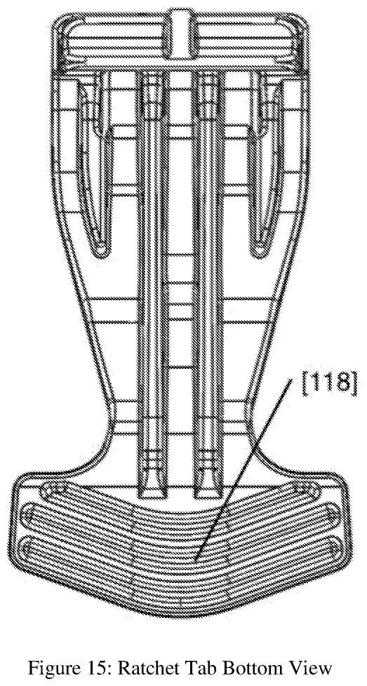

FIGS. 12 through 15 show the ratchet tab [103] in greater detail from a multitude of angles. The pivot through-hole [116] is identified (through which the first pivot pin [110] is inserted in the assembly of the compact ratcheting buckle mechanism [101]) and the ratchet tab teeth [109] are shown. Note how in FIG. 12 the ratchet tab handle [117] is wider than the rest of the ratchet tab [103] which allows for the ratchet tab [103] to be more easily manipulated with gross motor skills. FIG. 15 shows the underside of the ratchet tab handle [117], whereby a textured surface [118] is included to allow for better gripping and hence manipulation of the ratchet tab [103].

Due to the mechanical advantage afforded by the ratchet tab [103], the ratchet tab teeth [109] are liable to seeing significant force which could lead to material failure. To improve strength, a central ratchet tab rib [119] is included, attaching the teeth to the body increasing the strength resistance. This additional ratchet tab rib [119] material is accounted for in the compatible ratchet ladder strap [102] design, with a ratchet ladder teeth channel [123] in the compatible ratchet ladder strap [102] to allow the ratchet tab rib [119] to pass freely without interference (this will be detailed later in this section). Multiple ratchet tab ribs (following the ratchet tab rib [119] example) could be employed to further increase the ratchet tab teeth [109] strength; the compatible ratchet ladder strap [102] would be modified as appropriate to accommodate additional ratchet tab rib features.

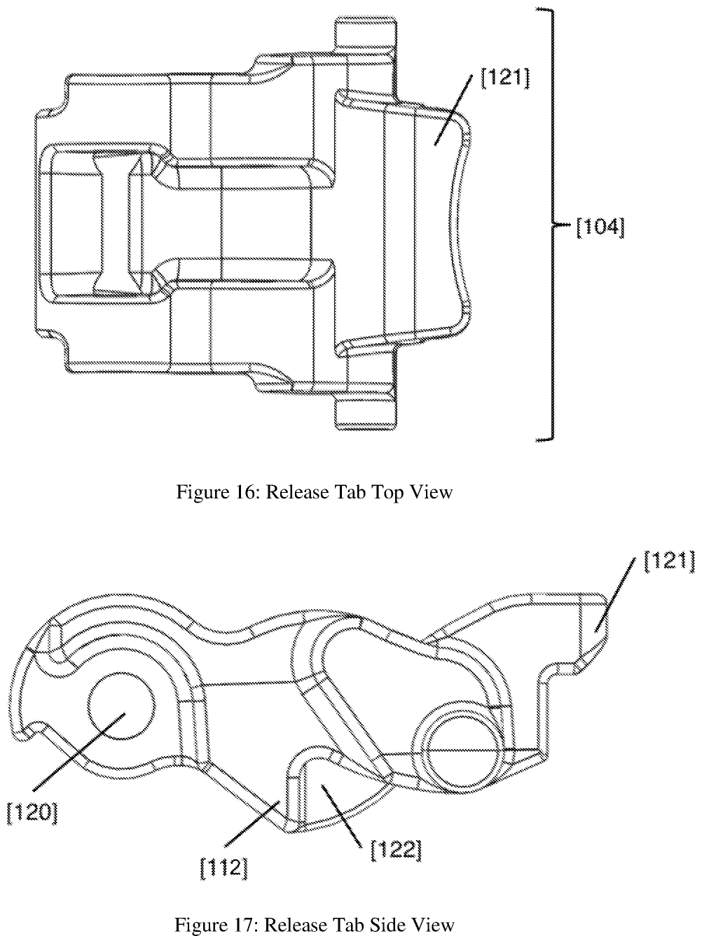

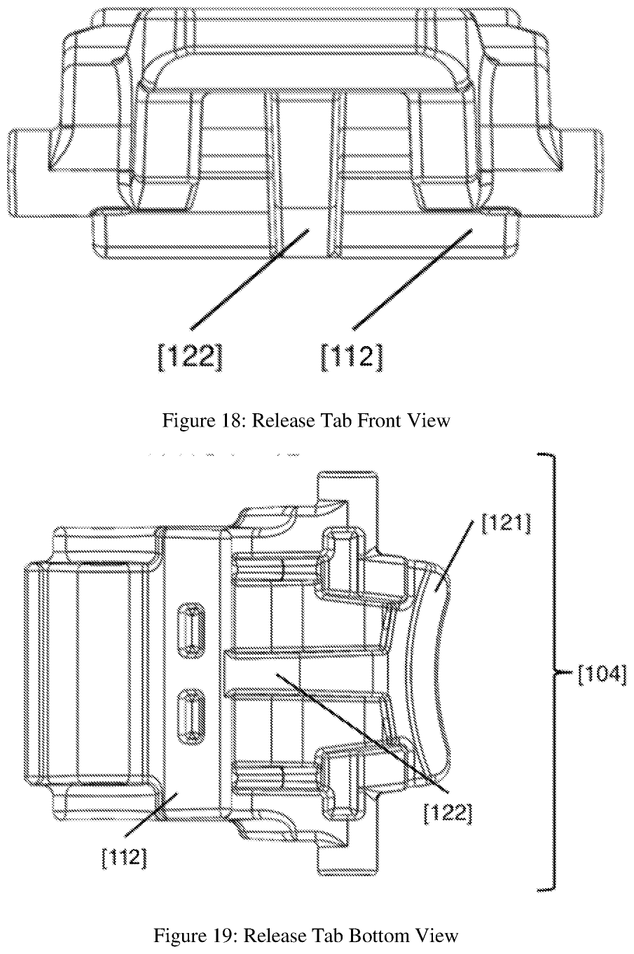

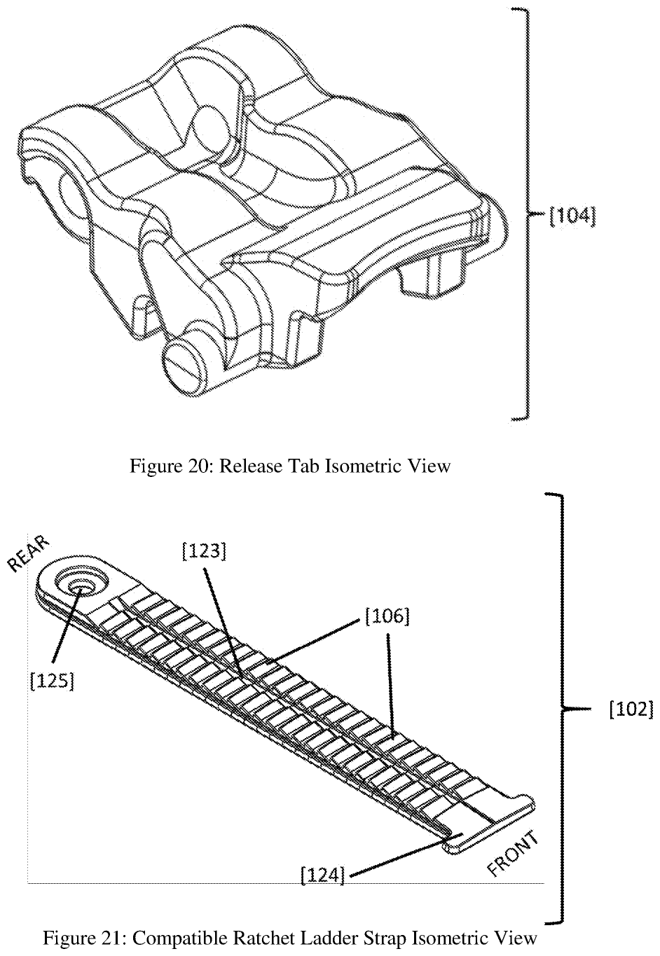

FIGS. 16 through 20 show the release tab [104] in greater detail from a multitude of angles. The pivot through-hole [120] is identified (through which the second pivot pin [111] is inserted in the assembly of the compact ratcheting buckle mechanism [101]) and the ratchet lock-tooth [112] is shown. FIGS. 16 and 17 show the gripping feature [121] on the release tab [104] for easier manipulation of the squeeze-release pincer motion described. Similarly to the ratchet tab [103], the release tab [104] features a release tab rib [122], which provides extra strength to the ratchet lock-tooth [111] stopping reverse sliding of the compatible ratchet ladder strap [102].

FIG. 21 shows the compatible ratchet ladder strap [102]. The ratchet ladder strap teeth [106] engage with the ratchet tab teeth [109], pushing the compatible ratchet ladder strap [102] in the forward direction (towards the FRONT). Note the ratchet ladder teeth channel [123], accommodating both the ratchet tab rib [119] and the release tab rib [122]. The compatible ratchet ladder strap [102] also has an anti-separation element [124] at the FRONT end, which cannot pass through the base plate [105] and therefore the compatible ratchet ladder strap [102] cannot separate completely from the compact ratcheting buckle mechanism [101]. Note also the constant cross-sectional area of the compatible ratchet ladder strap [102], allowing it to be fed into the ratcheting buckle mechanism [101] in the reverse direction (from the REAR end). The ratchet ladder strap hole [125] allows for attachment of the compatible ratchet ladder strap [102] using fastening hardware to a multitude of other components/fixings/hardware.

What is claimed is:

1. A compact ratcheting buckle mechanism, comprising:
a ratchet tab;
a release tab;
a base plate;
two double-torsion springs;
two pivot pins;
and
a compatible ratchet ladder strap,
the ratchet tab for advancing the mechanism, that is spring loaded by a double-torsion spring, and that is constrained within a first slot in the base plate by means of a first pivot pin,
the release tab for holding the mechanism in place until releasing the mechanism is desired, that is spring loaded by a double-torsion spring, and that is constrained within a second slot in the base plate by means of a second pivot pin,
the ratchet tab resting on top of the release tab when the compact ratcheting buckle mechanism is in its equilibrium resting state, the ratchet tab substantially covering the release tab from the top so that the release tab is only accessible for release from the end of the compact ratcheting buckle mechanism,
the compatible ratchet ladder strap being a long member with two or more ratchet teeth along its length that engage with the ratchet tab and release tab, and incrementally advances when the ratchet tab is articulated;
the ratchet tab having one or more ratchet tab teeth that engage with the compatible ratchet ladder strap,
the release tab having one or more release tab teeth that engage with the compatible ratchet ladder strap tooth, stopping the compatible ratchet ladder strap from moving in a backward direction thereby maintaining tension,
the ratchet tab and the release tab having the appropriate degrees of freedom to disengage from the compatible ratchet ladder so that any tension being held by the mechanism can be released when desired,
the ratchet tab where the ratchet tab handle is the widest section of the whole ratchet tab.

2. The compact ratcheting buckle mechanism of claim 1, wherein the appropriate degrees of freedom allow for a pincer motion to disengage the ratchet tab teeth and release tab teeth from the compatible ratchet ladder strap.

3. The compact ratcheting buckle mechanism of claim 1, wherein one or more ratchet tab teeth are strengthened with one or more ratchet tab ribs that run orthogonal to the ratchet tab teeth.

4. The compact ratcheting buckle mechanism of claim 3, wherein the compatible ratchet ladder strap is designed to accommodate the one or more ratchet tab ribs.

5. The compact ratcheting buckle mechanism of claim 1, wherein the one or more release tab teeth are strengthened with one or more release tab ribs that run orthogonal to the ratchet tab teeth.

6. The compact ratcheting buckle mechanism of claim 5, wherein the compatible ratchet ladder strap is designed to accommodate the one or more release tab ribs.

7. The compact ratcheting buckle mechanism of claim 1, wherein the ratchet tab handle of the ratchet tab has a textured surface allowing for easier manipulation. The compact ratcheting buckle mechanism of claim 1, wherein the base plate includes one or more constraint features that keep the ratchet ladder strap from moving orthogonal to the actuation direction.

8. The compact ratcheting buckle mechanism of claim 1, wherein the compatible ratcheting ladder strap has an anti-separation element formed to prohibit separation of the compatible ratchet ladder strap from the rest of the compact ratcheting buckle mechanism.

9. The compact ratcheting buckle mechanism of claim 1, wherein the compatible ratchet ladder strap has a constant cross sectional area to allow insertion into the rest of the compact ratcheting buckle mechanism from either direction.

10. The compact ratcheting buckle mechanism of claim 1, wherein the base plate is made from one continuous part.

11. The compact ratcheting buckle mechanism of claim 1, wherein the first and second pivot pins are semi-tubular rivets.

12. A compact ratcheting buckle mechanism, comprising:
a ratchet tab;
a release tab;
a base plate;
two double-torsion springs;
two pivot pins;
and
a compatible ratchet ladder strap,
the ratchet tab for advancing the mechanism, that is spring loaded by a double-torsion spring, and that is constrained within a first slot in the base plate by means of a first pivot pin,
the release tab for holding the mechanism in place until releasing the mechanism is desired, that is spring loaded by a double-torsion spring, and that is constrained within a second slot in the base plate by means of a second pivot pin,
the compatible ratchet ladder strap being a long member with two or more ratchet teeth along its length that engages with the ratchet tab and release tab, and incrementally advances when the ratchet tab is articulated;
the ratchet tab having one or more ratchet tab teeth that engage with the compatible ratchet ladder strap,
the one or more ratchet tab teeth are strengthened with one or more ratchet tab ribs that run orthogonal to the ratchet tab teeth;
the compatible ratchet ladder strap is designed to accommodate the one or more ratchet tab ribs,
the release tab having one or more release tab teeth that engage with the compatible ratchet ladder strap tooth, stopping the compatible ratchet ladder strap from moving in a backward direction thereby maintaining tension,
the ratchet tab and the release tab having the appropriate degrees of freedom to disengage from the compatible ratchet ladder so that any tension being held by the mechanism can be released when desired.

13. The compact ratcheting buckle mechanism of claim 12, wherein the appropriate degrees of freedom allow for a pincer motion to disengage the ratchet tab teeth and release tab teeth from the compatible ratchet ladder strap.

14. The compact ratcheting buckle mechanism of claim 12, wherein the one or more release tab teeth are strengthened with one or more release tab ribs that run orthogonal to the ratchet tab teeth.

15. The compact ratcheting buckle mechanism of claim 15, wherein the compatible ratchet ladder strap is designed to accommodate the one or more release tab ribs.

16. The compact ratcheting buckle mechanism of claim 12, wherein ratchet tab handle is the widest section of the whole ratchet tab.

17. The compact ratcheting buckle mechanism of claim 12, wherein the release tab rests on top of the ratchet tab when the compact ratcheting buckle mechanism is in its equilibrium resting state, the ratchet tab substantially covering the release tab from the top so as the release tab is only accessible for release from the end of the compact ratcheting buckle mechanism.
